(19) United States
(12) Patent Application Publication
(10) Pub. No.: US 2022/0147285 A1
(43) Pub. Date: May 12, 2022

(54) IMAGE FORMING APPARATUS, AND CONTROL METHOD FOR IMAGE FORMING APPARATUS

(71) Applicant: SHARP KABUSHIKI KAISHA, Sakai City (JP)

(72) Inventor: KUNIHISA CHIBA, Sakai City (JP)

(21) Appl. No.: 17/514,864

(22) Filed: Oct. 29, 2021

(30) Foreign Application Priority Data
Nov. 9, 2020 (JP) 2020-186775

(51) Int. Cl. G06F 3/12; H04N 1/32

(52) U.S. Cl. CPC G06F 3/1205; G06F 3/1273; H04N 1/32101; G06F 3/1204

(57) ABSTRACT

An image forming apparatus capable of executing a job on the basis of a set value, and storing a history of the job, the image forming apparatus including: a storage that stores, as setting history information, the set value of the executed job; a display that displays the setting history information stored in the storage; and a controller that executes the job based on the setting history information displayed on the display, wherein when the controller receives a display change instruction for the setting history information, the controller changes a display format of the setting history information from execution order of the job to a display format pertaining to the display change instruction.

### BACKGROUND OF THE INVENTION

### Field of the Invention

The present invention relates to an image forming apparatus and the like.

### Description of the Background Art

An image forming apparatus such as a multifunction peripheral executes jobs such as printing, faxing, and scanning. The image forming apparatus keeps an execution history of the executed jobs such as printing, faxing, and scanning as job history information.

The job history information is record information pertaining to the execution of jobs such as a job ID, a function, a user name, a document name, the number of pages/the number of sets, start date and time/end date and time, and a status, as illustrated in FIG. 26, for example. The image forming apparatus displays some items included in the job history information as a job history to a user. The user can confirm his/her own job by referring to the job history.

For display of the job history, various display methods are proposed, for example, as disclosed in Japanese Unexamined Patent Application Publication No. 2018-125687. However, the job history information is merely a record of job execution and cannot be used as a memorandum.

When a job is executed, a set value suitable for the purpose of execution of the job is set. The image forming apparatus acquires an input value by a user, an initial set value specific to the apparatus, or the like as a set value. The image forming apparatus executes a job on the basis of the acquired set values, so that the user can obtain a desired job execution result.

The set value history information (hereinafter referred to as the setting history information) is history information that exhaustively records the set value for the job executed by each user. Therefore, for example, the setting history information is useful information for a user who wants to re-execute the same job or a job similar to the above job.

As mentioned above, the purpose and the usage of the job history information and the setting history information are very different. There are a lot of prior arts including a display method and the like for the job history information, but there is no useful prior art including a display method and the like for effective use of the setting history information.

In view of the above problem, an object of the present disclosure is to provide an image forming apparatus and the like that can facilitate grasping of setting contents pertaining to job execution by displaying setting history information to a user and that enables improvement of convenience pertaining to the job execution.

### SUMMARY OF THE INVENTION

In order to solve the above problem, an image forming apparatus of the present disclosure is an image forming apparatus capable of executing a job on the basis of a set value, and storing a history of the job, the image forming apparatus including: a storage that stores, as setting history information, the set value of the executed job; a display that displays the setting history information stored in the storage; and a controller that executes the job based on the setting history information displayed on the display, wherein when the controller receives a display change instruction for the setting history information, the controller changes a display format of the setting history information from execution order of the job to a display format pertaining to the display change instruction.

A control method of the present invention is a control method for an image forming apparatus capable of executing a job on the basis of a set value, and storing a history of the job, the control method including: storing, as setting history information, the set value of the executed job; displaying the setting history information stored in the storing; and controlling execution of the job based on the setting history information displayed on the displaying, wherein in the controlling, when a display change instruction for the setting history information is received, a display format of the setting history information is changed from execution order of the job to a display format pertaining to the display change instruction.

According to the present disclosure, it is possible to facilitate grasping of setting contents pertaining to job execution by displaying setting history information to a user and enable the execution of the job from the setting history information, and therefore it is possible to improve convenience pertaining to the job execution.

### BRIEF DESCRIPTION OF THE DRAWINGS

FIG. 1 is an external perspective diagram of a multifunction peripheral in a first embodiment;

FIG. 2 is a diagram illustrating a functional configuration of the multifunction peripheral in the first embodiment;

FIG. 3 is a diagram illustrating a configuration example of setting history information;

FIG. 4 is a flowchart illustrating the flow of a process in the first embodiment;

FIG. 5 is a flowchart illustrating the flow of a process in the first embodiment;

FIG. 6 is a flowchart illustrating the flow of a process in the first embodiment;

FIG. 7 is a flowchart illustrating the flow of a process in the first embodiment;

FIG. 8 is a flowchart illustrating the flow of a process in the first embodiment;

FIG. 9 is a diagram illustrating an operation example in the first embodiment;

FIG. 10 is a diagram illustrating an operation example in the first embodiment;

FIG. 11 is a diagram illustrating an operation example in the first embodiment;

FIGS. 12A to 12D indicate a diagram illustrating an operation example in the first embodiment;

FIGS. 13A to 13B indicate a diagram illustrating an operation example in the first embodiment;

FIGS. 14A to 14B indicate a diagram illustrating an operation example in the first embodiment;

FIGS. 15A to 15B indicate a diagram illustrating an operation example in the first embodiment;

FIG. 16 is a diagram illustrating a functional configuration of a multifunction peripheral in a second embodiment;

FIG. 17 is a flowchart illustrating the flow of a process in the second embodiment;

FIG. 18 is a diagram illustrating an operation example in the second embodiment;

FIG. 19 is a diagram illustrating an operation example in the second embodiment;

FIGS. 20A to 20B indicate a diagram illustrating an operation example in the second embodiment;

FIGS. 21A to 21B indicate a diagram illustrating an operation example in the second embodiment;

FIGS. 22A to 22B indicate a diagram illustrating an operation example in the second embodiment;

FIG. 23 is a diagram illustrating a functional configuration of a multifunction peripheral in a third embodiment;

FIG. 24 is a flowchart illustrating the flow of a process in the third embodiment;

FIG. 25 is a diagram illustrating an operation example in the third embodiment; and

FIG. 26 is a diagram illustrating a configuration example of job history information.

### DESCRIPTION OF THE PREFERRED EMBODIMENTS

Hereinafter, embodiments of the present invention will be described with reference to the drawings. In this disclosure, as an example, a multifunction peripheral that has a print function including a copy, a fax communication function, or a scan function, and the like and that performs a process associated with execution of each function per job, as an image forming apparatus, will be described. The following embodiments are examples for illustrating the present disclosure, and the technical scope of the description described in the claims is not limited to the following description.

### 1. First Embodiment

### 1.1 Functional Configuration

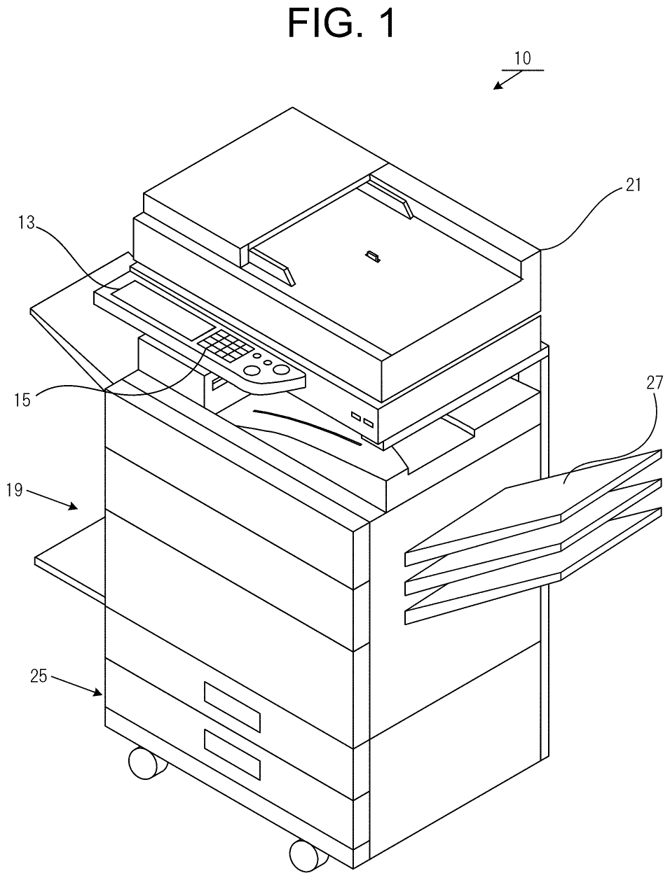

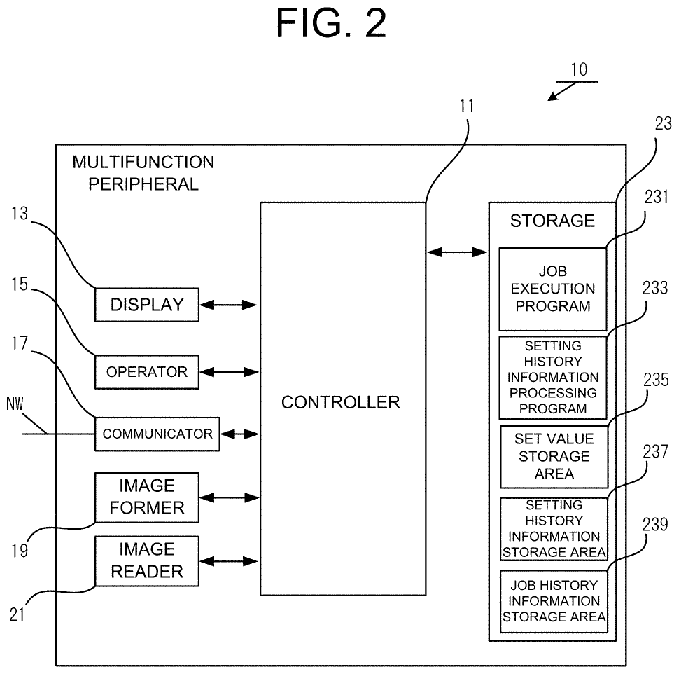

A functional configuration of a multifunction peripheral 10 as an image forming apparatus according to this embodiment will be described with reference to FIG. 1 and FIG. 2. FIG. 1 is an external perspective diagram for illustrating an overall configuration of the multifunction peripheral 10. FIG. 2 is a functional configuration diagram of the multifunction peripheral 10.

The multifunction peripheral 10 has a copy function that forms an image on paper as a recording medium from image data generated by a scan function, and a print function that forms an image on paper on the basis of image data acquired from an external terminal device, a portable storage medium, or the like (the copy function and the print function are collectively referred to as the print function). The multifunction peripheral 10 is also provided with a fax function for sending and receiving a fax via a public telephone communication network or the like, a temporary data storage function for temporarily storing received fax data, and the like.

As illustrated in FIG. 1 and FIG. 2, the multifunction peripheral 10 includes a controller 11, a display 13, an operator 15, a communicator 17, an image former 19, an image reader 21, a storage 23, a paper feed tray 25, and a paper discharge tray 27.

The controller 11 controls the overall multifunction peripheral 10. The controller 11 is composed of, for example, one or more arithmetic devices (such as a central processing unit (CPU)). The controller 11 realizes its function by reading out and executing a job execution program 231 and a setting history information processing program 233 stored in the storage 23.

The display 13 displays various information to a user. The display 13 can be composed of, for example, an LCD (liquid crystal display) or an organic EL (electro-luminescence) display.

The operator 15 receives input of information such as a set value by the user. The operator 15 can be composed of hard keys (e.g., a numeric keypad), buttons, and the like. The operator 15 can be configured as a touch panel that allows input via the display 13. In this case, for example, a resistive film method, an infrared method, an electromagnetic induction method, and a capacitance method can be adopted as an input detection method of the touch panel.

The communicator 17 is connected to other devices via a network (NW) such as a local area network (LAN), wide area network (WAN), the Internet, and a public telephone network, and sends and receives various information such as image data and fax data. The communicator 17 is configured, for example, as a communicable interface, and the connection method can be employed by wired and/or wireless connection.

The image former 19 forms an image based on image data on paper. The image former 19 feeds paper from the paper feed tray 25, forms an image based on the image data on the paper, and thereafter discharges the paper to the paper discharge tray 27. The image former 19 can be composed of a laser printer or the like using an electrophotographic method. The image former 19 performs image formation by using toner supplied from toner cartridges corresponding to respective toner colors (such as yellow (Y), magenta (M), cyan (C), and black (K)).

The image reader 21 generates image data by reading an image to be read. The image reader 21 can be composed of a scanner device or the like that converts an image into an electrical signal by an image sensor such as a CCD (charge coupled device) and a CIS (contact image sensor), and generates digital data by quantizing and encoding the electrical signal.

The storage 23 stores various programs and various data necessary for the operation of the multifunction peripheral 10. The storage 23 can be composed of, for example, a volatile memory such as a RAM, a non-volatile memory such as an SSD (solid state device), an HDD (hard disk drive) and a ROM (read only memory) as semiconductor memories.

In this embodiment, the storage 23 stores the job execution program 231 and the setting history information processing program 233, and secures a set value storage area 235, a setting history information storage area 237, and a job history information storage area 239.

The job execution program 231 is a program that is read out by the controller 11 in order to perform a process associated with the execution of a print function, a fax communication function, a scan function, or the like, per job. The controller 11 reads out the job execution program 231 and executes each job pertaining to the print function, the fax communication function, the scan function, or the like, by controlling the image former 19, the communicator 17, or the image reader 21.

The setting history information processing program 233 is a program that is read out by the controller 11, for example, when acquisition of a set value or the like pertaining to the execution of a job, generation of setting history information, a process for the setting history information, a display instruction of the setting history information to the display 13, or generation of job history information is performed.

The set value storage area 235 is a storage area for storing various set values pertaining to the execution of a job. The set values include a set value set by a user in the execution of a job, a device initial value held by the device itself, and the like.

Each set value stored in the set value storage area 235 may be a value directly input by the user via the operator 15 or a touch panel or the like displayed on the display 13. When the multifunction peripheral 10 is connected to an external terminal device (not illustrated) or the like via the communicator 17, the controller 11 can also acquire the set value input via a control program such as a printer driver introduced in the external terminal device. The controller 11 stores the acquired set value in the set value storage area 235.

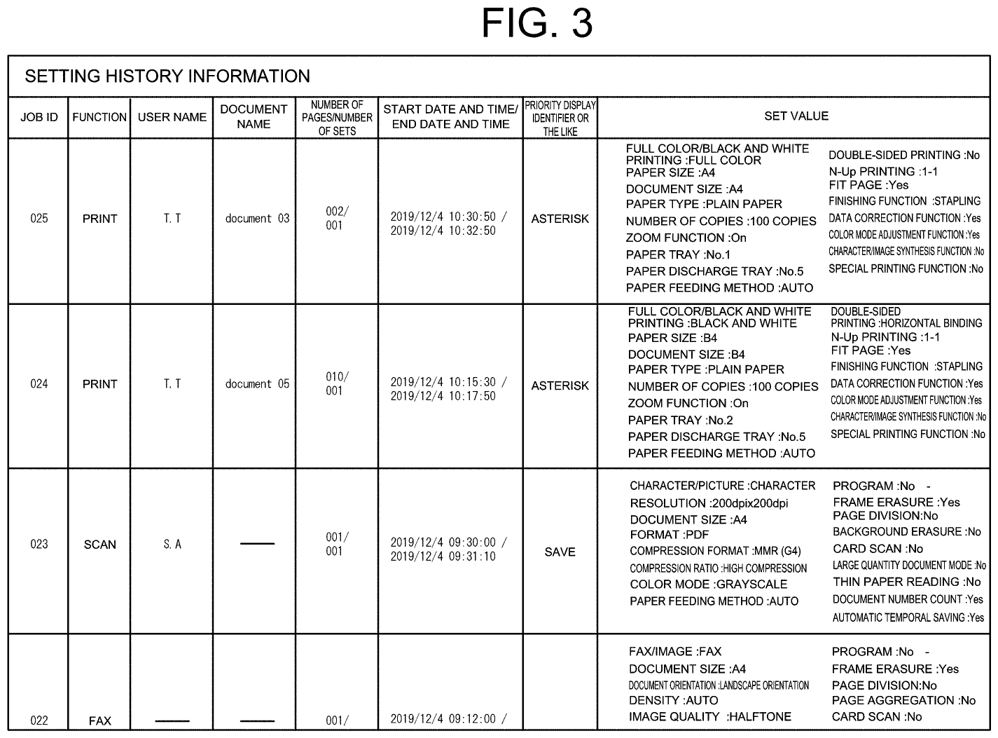

The setting history information storage area 237 is a storage area for storing setting history information in a data table format illustrated in FIG. 3. The setting history information according to the first embodiment is history information obtained by attaching an ID (job ID) for uniquely identifying information to information composed of a combination of some or all of the set values stored in the set value storage area 235 and history information pertaining to the execution of a job such as a job function, an execution user name, and execution date and time.

Herein, each item of the setting history information will be described with reference to FIG. 3. FIG. 3 illustrates a configuration example of a case where the setting history information is stored in the data table format. The job ID is an ID that uniquely identifies the setting history information corresponding to a job. The function means a job function such as a print function, a fax function, and a scan function. The user name is a name of a user who executes a job. The document name is character information for identify a document, which is arbitrarily set by a user. The number of pages/the number of sets is the number of pages or sets of documents to be served for a job. The start date and time/end date and time is start date and time and end date and time of job execution.

The priority display identifier or the like is an identifier (e.g., character information such as a star (asterisk) or “save”) that a user himself or herself attaches to setting history information to which the user pays attention (such as setting history information that the user wants to be displayed preferentially by marking those having a specific setting history).

The set value is a set value stored in the set value storage area 235. The set values included in the setting history information can be selected as long as the set values are the set values stored in the set value storage area 235. For example, taking the setting history information for a print job with Job ID “#025” as an example, “full color” is stored as the set value of set value item: full color/black and white printing. Similarly, “A4” is stored as the set value of set value item: paper size. The set values according to the present disclosure are not limited to those illustrated in FIG. 3, and any set values pertaining to the execution of a job can be referred to as the set values composing this setting history information.

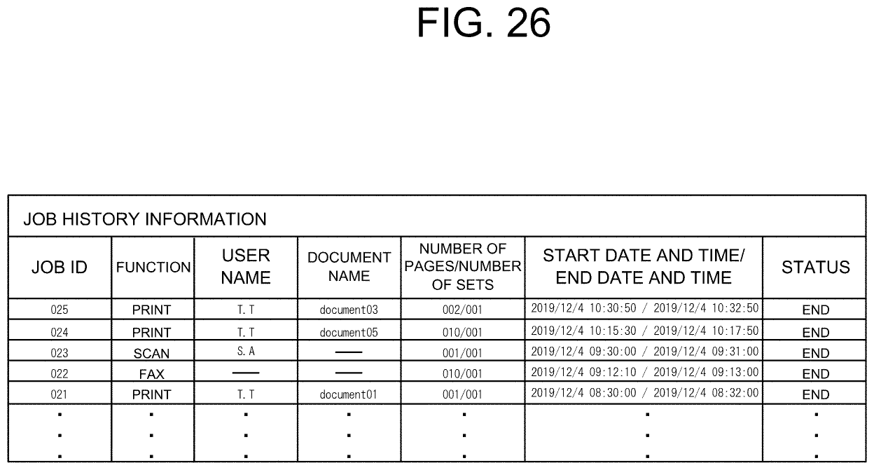

Returning again to FIG. 2, the job history information storage area 239 is a storage area for storing job history information in the data table format illustrated in FIG. 26. The job history information according to the first embodiment is execution record information of a job including a job ID, a function, a user name, a document name, the number of pages/the number of sets, start date and time/end date and time, and a status. The job history information may be generated after a job is executed, or can be generated by extracting the items necessary for generating the job history information from the items of the setting history information after the setting history information is generated.

### 1.2 Flow of Process

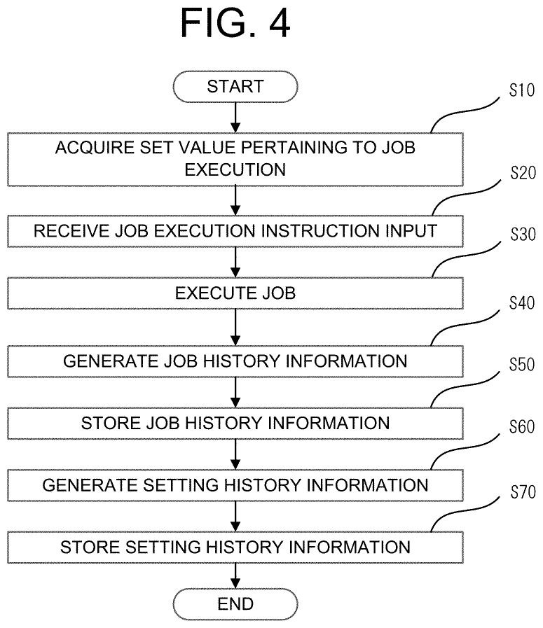

Now, the flow of a process of the multifunction peripheral 10 of this embodiment will be described with reference to FIG. 4 to FIG. 8.

First, a process mainly executed by the controller 11 from the acquisition of the set value for job execution to the storage of the setting history information will be described with reference to a flowchart in FIG. 4. In the description of the process in FIG. 4, it is assumed that the setting history information is generated after the job history information is generated, but the order of the generation of the job history information and the setting history information may be reversed.

The controller 11 executes this process by reading out the job execution program 231 and the setting history information processing program 233.

In Step S10, first, when a set value pertaining to any of a print job, a fax job, and a scan job is input by a user, the controller 11 acquires the set value pertaining to the job execution. The controller 11 stores the acquired set value in the set value storage area 235. When no set value is input by the user, the controller 11 may acquire a device specific initial value as the set value.

In Step S20, the controller 11 receives input of job execution instruction by receiving the press of a start button or the like (not illustrated) in the operator 15, the display 13 or the like.

The controller 11 executes the job on the basis of the set value acquired in Step S10 (Step S30).

In Step S40, the controller 11 generates the job history information (see FIG. 26) pertaining to the executed job. Next, in Step S50, the controller 11 stores the generated job history information in the job history information storage area 239. The job history information stored in the job history information storage area 239 can be used for the display of the job history and the like.

In Step S60, the controller 11 reads out the set value pertaining to the executed job from the set value storage area 235. The controller 11 generates the setting history information obtained by attaching an ID for uniquely identifying information to information composed of the combination of the read set value and the history information pertaining to the execution of the job such as a job function, an execution user name, and the execution date and time (see FIG. 3). Next, in Step S70, the controller 11 stores the generated setting history information in the setting history information storage area 237.

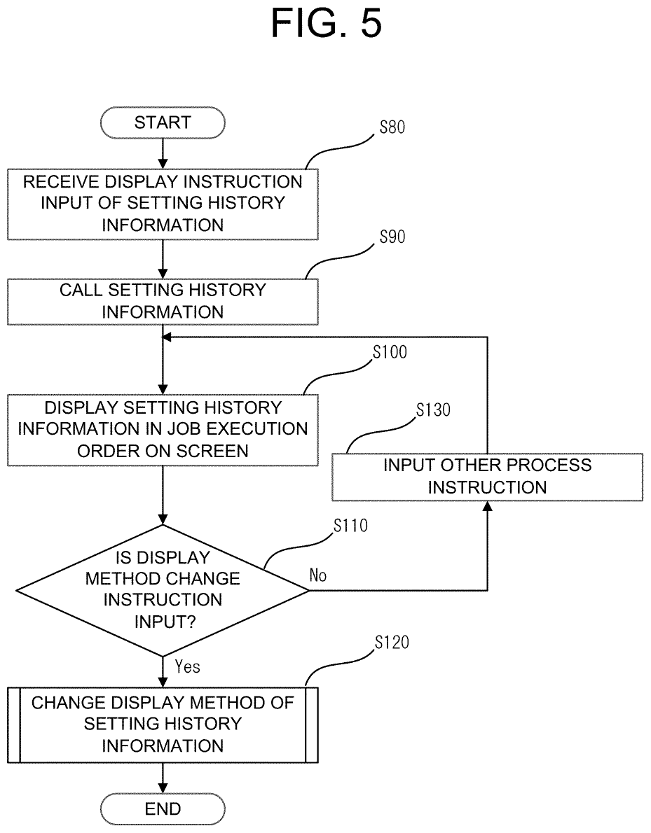

Now, a process mainly executed by the controller 11 from the display of the generated setting history information to the receipt of a display method change instruction of the setting history information will be described with reference to a flowchart in FIG. 5.

The controller 11 executes this process by reading the setting history information processing program 233. In this specification, it is described as “screen display” that the controller 11 calls, from the storage 23, the setting history information and the setting history information processing program 233 to be displayed, and displays screen data on the display 13.

The controller 11 receives display instruction input of the setting history information by receiving the press of a display instruction button or the like (not illustrated) in the operator 15, the display 13, or the like (Step S80).

The controller 11 calls the setting history information from the setting history information storage area 237 (Step S90). At this time, the controller 11 calls pieces of setting history information by the number according to an displayable area of the display 13 (for example, the maximum number of pieces of the setting history information that can be displayed with a single display instruction).

The controller 11 displays the called pieces of setting history information in a format screen arranged in the order of job execution from the newest (Step S100).

Then, the controller 11 executes a display method change process for the pieces of setting history information (Step S120) when a display method change instruction button or the like (not illustrated) in the operator 15, the display 13, or the like is pressed and the received input is a display method change instruction (Yes in Step S110).

On the other hand, when the received input is not the display method change instruction (No in Step S110), the controller 11 determines that the received input is other processing instruction for pieces of the setting history information other than the display method change instruction.

The controller 11 executes other process for pieces of the setting history information (Step S130).

After executing the other process, the controller 11 continues the screen display of pieces of the setting history information in the order of job execution (Step S100).

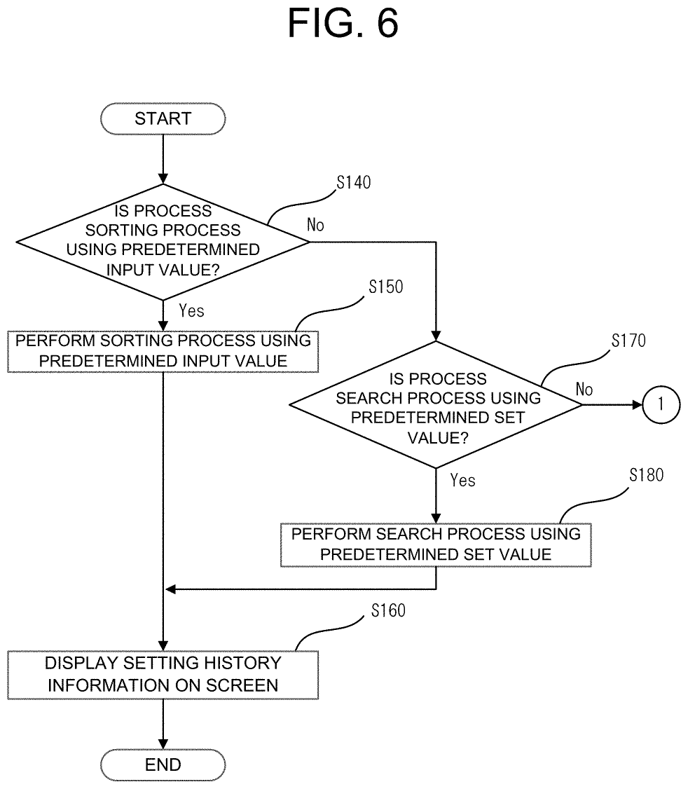

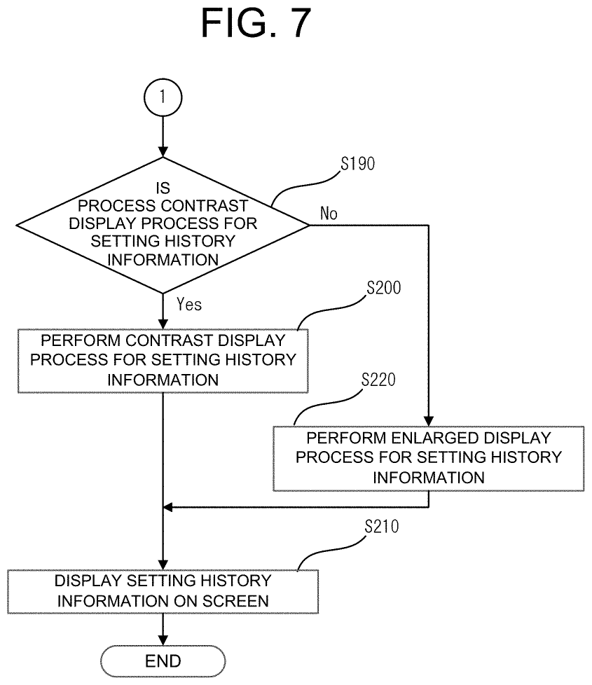

Now, a process mainly executed by the controller 11 from the time when the display method change instruction input is received to the time when pieces of the setting history information after the display method change are displayed will be described with reference to FIG. 6 and FIG. 7.

The controller 11 executes this process by reading out the setting history information processing program 233.

When receiving the display method change instruction input, the controller 11 determines whether or not the display method pertaining to the change of the screen display is a setting history information sorting process using a predetermined input value.

When it is determined that the process is the setting history information sorting process using the predetermined input value (Yes in Step S140), the controller 11 performs the sorting process for pieces of the setting history information by using the predetermined input value (Step S150).

Then, the controller 11 displays a sorting result of the setting history information on the screen (Step S160).

On the other hand, when it is determined that the process is not the setting history information sorting process using the predetermined input value (No in Step S140), the controller 11 determines whether or not the display method pertaining to the change of the screen display is a setting history information search process using a predetermined set value.

When it is determined that the process is the setting history information search process using the predetermined search value (Yes in Step S170), the controller 11 perform the search process for pieces of the setting history information by using the predetermined search value (Step S180).

Then, the controller 11 displays a search result of pieces of the setting history information on the screen (Step S160).

On the other hand, when it is determined that the process is not the setting history information search process using the predetermined set value (No in Step S170), the controller 11 determines whether or not the display method pertaining to the changing of the screen display is a contrast display process for the setting history information.

When it is determined that the process is the contrast display process for the setting history information (Yes in Step S190), the controller 11 performs the contrast display process for the setting history information (Step S200).

Then, the controller 11 displays a contrast display process result on the screen (Step S210).

On the other hand, when it is determined that the process is not the contrast display process for the setting history information (No in Step S190), the controller 11 determines that the display method pertaining to the screen display change is an enlarged display process for the setting history information, and executes this process (Step S220).

Then, the controller 11 displays an enlarged display process result on the screen (Step S210).

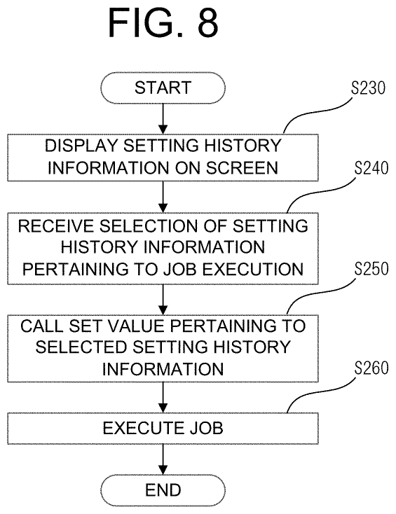

Now, a process mainly executed by the controller 11 from the screen display of the setting history information to the job execution will be described with reference to a flowchart in FIG. 8.

The controller 11 executes this process by reading out the setting history information processing program 233 and the job execution program 231.

The controller 11 displays pieces of the setting history information on the screen on the basis of the process described in FIG. 4 to FIG. 7 (Step S230).

When a user selects setting history information pertaining to job execution from pieces of the setting history information displayed on the screen, the controller 11 receives this selection (Step S240).

In Step S250, the controller 11 calls the set value pertaining to the selected setting history information from the set value storage area 235.

The controller 11 executes the job on the basis of the called set values (Step S260) and ends the process.

### 1.3 Operation Example

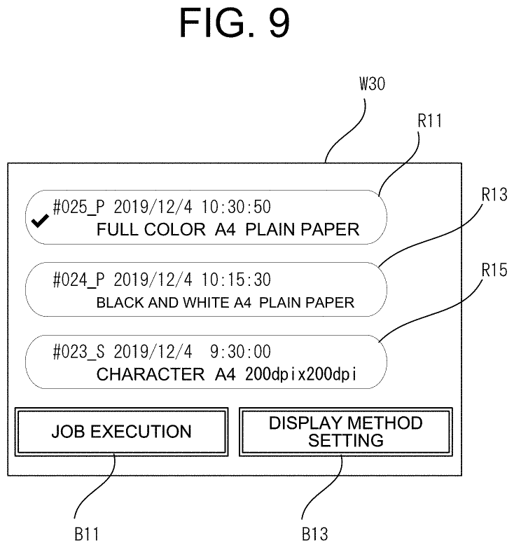

Now, an operation example of the multifunction peripheral 10 according to this embodiment will be described with reference to FIG. 9 to FIGS. 15A to 15B.

FIG. 9 is a configuration example of a setting history information screen W30 displayed by the controller 11. This operation corresponds to the process pertaining to Step S100 in FIG. 5.

The setting history information screen W30 includes setting history information display areas R11 to R15, a job execution button B11, and a display method setting button B13. The setting history information display areas R11 to R15 are configured by arraying pieces of setting history information in parallel in chronological order of job execution from the newest one or in the order of processing results by the controller 11. The example illustrated in FIG. 9 is an example of three lines of pieces of the setting history information in parallel. The number of parallel lines of the setting history information is not limited to three lines, but can be set appropriately according to the display space of the display 13.

All the information displayed on the screen in the setting history information display areas R11 to R15 are information that the controller 11 reads out from the setting history information. In the example illustrated in FIG. 9, the setting history information display areas R11 to R15 each include a job ID, a job execution date and time, and a set value.

The setting history information display area R11 will be described as an example. The job ID is an identifier that corresponds to an executed job and uniquely identifies the setting history information. The job ID according to this embodiment is marked with an alphabetic character representing each job function (print function: P, fax function: F, scan function: S) such that the user can identify the job function at a glance. For example, Job ID “#025_P” is a 25th executed job and indicates a job pertaining to the print function. The job execution date and time indicates date and time when a job is executed.

The set value indicates a set value included in the setting history information. The set value items displayed in the setting history information display area can be changed and set as appropriate according to the degree of user attention, such as set value items that are likely to be changed according to the job (such as full color/black and white printing, paper size, document size, paper type, and the number of copies) and set value items that cannot produce a desired execution result unless a user who executes the next job grasps the fact that the set value is changed (such as duplex printing, N-Up printing, and fit page).

In the example of the setting history information display area R11, as a display example of the set values, set value item: “full color” of full color/black and white printing, set value item: “A4” of paper size, and set value item: “plain paper” of paper type are displayed.

Similarly, Job ID “#024_P” in the setting history information display area R13 is a 24th executed job and indicates a print job pertaining to the print function, and Job ID “#023_S” in the setting history information display area R15 is a 23rd executed job and indicates a scan job pertaining to the scan function.

Accordingly, the setting history information screen W30 illustrated in FIG. 9 is an example in which the 25th print job at 10:30:50 on Dec. 4, 2019, the 24th print job at 10:15:30 on Dec. 4, 2019, and the 23rd scan job at 9:30:00 on Dec. 4, 2019 are chronologically arranged.

The job execution button B11 is a button that receives the input of a re-execution instruction of the job selected by the user. The user puts a check mark in the setting history information display area R11, and presses the job execution button B11. Upon receiving the press of the job execution button B11, the controller 11 executes the process illustrated in FIG. 8 to allow the user to re-execute a desired job.

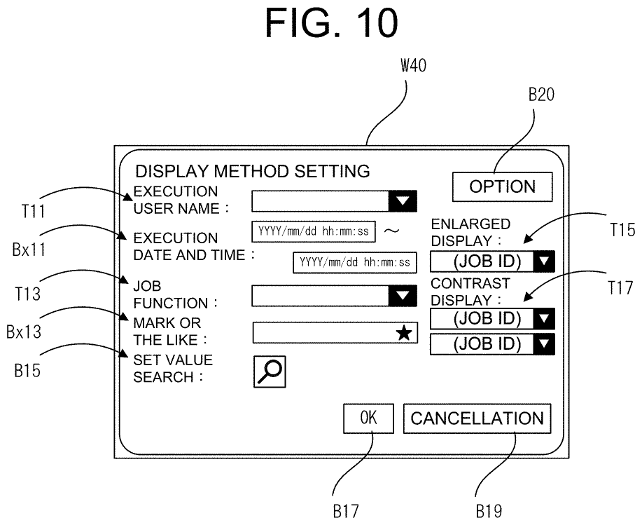

The display method setting button B13 is a button that receives the display change instruction input of the setting history information by the user. When the controller 11 receives the press of the display method setting button B13, the display method setting screen W40 illustrated in FIG. 10 is displayed on the screen. The user can execute the display method change or a process other than the display method change via the display method setting screen W40.

FIG. 10 is a configuration example of the display method setting screen W40 which is displayed by the controller 11 after reception of the press of the display method setting button B13.

The display method setting screen W40 includes an execution user name input tab T11, an execution date and time input box Bx11, a job function selection tab T13, a mark or the like input box Bx13, a set value search button B15, an enlarged display input tab T15, a contrast display input tab T17, an OK button B17, a cancellation button B19, and an option button B20.

The execution user name input tab T11, the execution date and time input box Bx11, the job function selection tab T13, and the mark or the like input box Bx13 are items that are input and selected by the user when the screen display of the setting history information in the chronological order illustrated in FIG. 9 is changed to the display of the result of the setting history information sorting process based on the predetermined input values. This operation corresponds to the processes pertaining to Steps S110 and S120 in FIG. 5 and Step S140 to Step S160 in FIG. 6.

The execution user name input tab T11 is a tab that receives the selection of the user name that executes the job. When the controller 11 receives the selection of the execution user via the execution user name input tab T11, the controller 11 performs a sorting process for pieces of the setting history information on the basis of the inputted execution user name, and displays the result of this sorting process on the screen.

The execution date and time input box Bx11 is a box that receives the designation of the date and time when the job was executed. The date and time can be designated by inputting a period unit in which the job was executed or the date and time when the job was executed. When the controller 11 receives the input of the period or the date and time designation via the execution date and time input box Bx11, the controller 11 performs a sorting process for pieces of the setting history information on the basis of the input period or date and time, and displays the result of this sorting process on the screen.

The job function selection tab T13 is a tab that receives the selection of the job function for the executed job. When the controller 11 receives the selection of a job function via the job function selection tab T13, the controller 11 performs a sorting process for pieces of the setting history information on the basis of the input job function, and displays the result of this sorting process on the screen.

The mark or the like input box Bx13 is a box that receives the input of a priority display identifier (mark) or the like attached by the user. When the controller 11 receives the input of a priority display identifier (mark) via the mark or the like input box Bx13, the controller 11 performs a sorting process for pieces of the setting history information on the basis of the input priority display identifier (mark) and displays the result of this sorting process on the screen. The priority display identifier can be added via an option screen W50 that is displayed in response to the press of the option button B20.

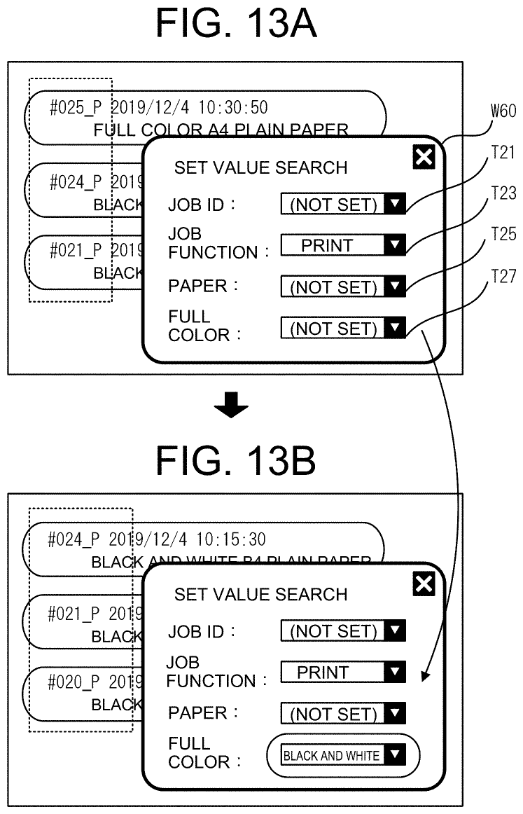

The set value search button B15 is a button that is selected by the user when the screen display of pieces of the setting history information in chronological order illustrated in FIG. 9 is changed to the display of the result of the setting history information sorting process based on a predetermined set value. This operation corresponds to the processes pertaining to Steps S110 and S120 of FIG. 5 and Steps S170, S180, and S160 of FIG. 6. The controller 11 receives the press of the set value search button B15 and displays a set value search screen W60 illustrated in FIGS. 13A to 13B on the screen. A predetermined set value can be selected via the set value search screen W60.

When the controller 11 receives the selection of the predetermined set value via the set value search screen W60, the controller 11 performs a sorting process for pieces of the setting history information on the basis of this set value and displays the result of this sorting process on the screen.

The enlarged display input tab T15 is a tab that receives the selection of the setting history information to be enlarged and displayed for each job ID. When the controller 11 receives the selection of the setting history information to be enlarged and displayed via the enlarged display input tab T15, the controller 11 performs an enlarged display process for the setting history information and displays the enlarged setting history information on the screen. This operation corresponds to the processes of Step S190, Step S220, and Step S210 in FIG. 7.

The contrast display input tab T17 is a tab that receives the selection of pieces of the setting history information to be displayed in contrast for each job ID. When the controller 11 receives the selection of pieces of the setting history information to be contrasted and displayed via the contrast display input tab T17, the controller 11 performs a contrast display process for pieces of the setting history information and displays the contrasted pieces of setting history information on the screen. This operation corresponds to the processes of Steps S190, S200, and S210 in FIG. 7.

The OK button B17 is a button that receives input approval by the user. The cancellation button B19 is a button that receives input cancellation by the user.

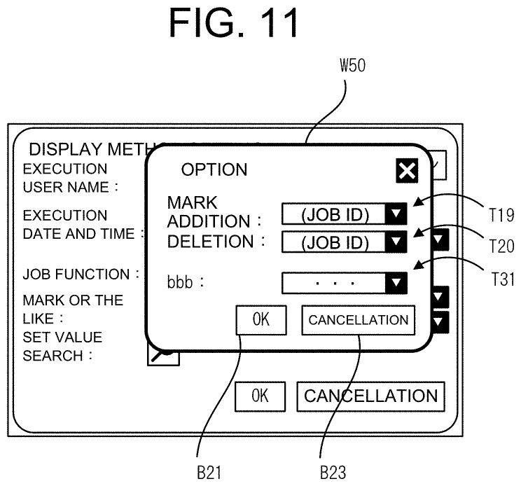

The option button B20 is a button that receives other processing instruction input other than the display method change instruction for pieces of the setting history information. When the controller 11 receives the press of the option button B20, the option screen W50 illustrated in FIG. 11 is displayed on the screen.

The option screen W50 includes a mark addition input tab T19, a deletion tab T20, an arbitrary option tab (bbb) T31, an OK button B21, and a cancellation button B23.

The mark addition input tab T19 is a tab that receives the selection of the setting history information to which the aforementioned priority display identifier is added by inputting a job ID. When the controller 11 receives an instruction to add a priority display identifier via the mark addition input tab T19, the controller 11 adds the priority display identifier to the setting history information.

The deletion tab T20 is a tab that receives the selection of the setting history information to be deleted by inputting a job ID. When the controller 11 receives an instruction to delete this setting history information via the deletion tab T20, the controller 11 deletes the setting history information from the setting history information storage area 237. The operation pertaining to the input of other processing instruction via the option screen W50 corresponds to the process pertaining to Step S130 of FIG. 5.

Although the arbitrary option tab (bbb) T31 is not particularly limited, an arbitrary option (such as selection of a mark type) can be assigned to the arbitrary option tab (bbb) T31 by a user.

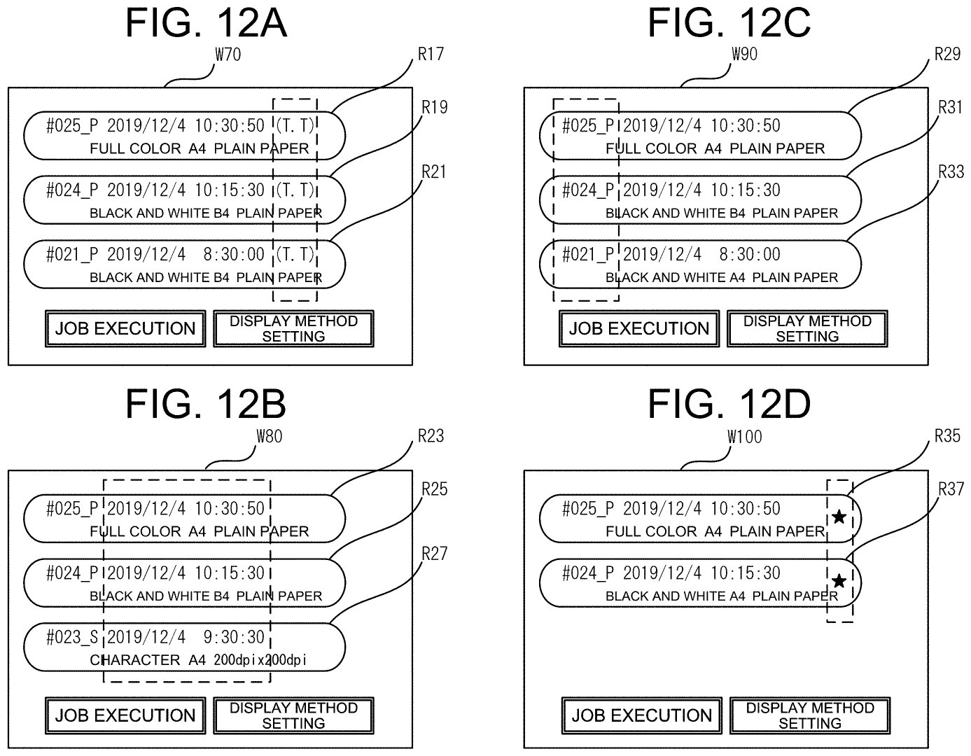

FIGS. 12A to 12D is a display example of the result of the sorting process of the setting history information. FIG. 12A is a diagram illustrating a result of a sorting process of the setting history information based on the execution user name. FIG. 12B is a diagram illustrating a result of a setting history information sorting process based on the execution date and time. FIG. 12C is a diagram illustrating a result of a setting history information sorting process based on the job function. FIG. 12D is a diagram illustrating a result of a setting history information sorting process based on the priority display identifier.

FIG. 12A is a screen display example of a result of a sorting process in a case where the initials of the user who executes a job is T. T. An area surrounded by a dotted line in FIG. 12A represents the name of the user who executed the job. When there is no need to display the execution user name, the name may not be displayed.

In the example of FIG. 12A, Job ID “#025_P” in a setting history information display area R17 of a screen W70 is a job ID for the 25th print job by a user (T. T.), and the job execution date and time is 10:30:50 on Dec. 4, 2019. The set values of this job are set value item: “full color” of full color/black and white printing, set value item: “A4” of paper size, and set value item: “plain paper” of paper type.

Similarly, Job ID “#024_P” in a setting history information display area R19 is a job ID for the 24th print job by the user (T. T.), and the job execution date and time is 10:15:30 on Dec. 4, 2019. The set values of this job are set value item: “black and white” of full color/black and white printing, set value item: “B4” of paper size, and set value item: “plain paper” of paper type.

Similarly, Job ID “#021_P” in a setting history information display area R21 is a job ID for the 21st print job by the user (T. T.), and the job execution date and time is 8:30:00 on Dec. 4, 2019. The set values of this job are set value item: “black and white” of full color/black and white printing, set value item: “B4” of paper size, and set value item: “plain paper” of paper type.

FIG. 12B is a screen display example of a result of sorting process in a case where the date and time (period) when the job was executed is from 9:30:30 to 10:30:50 on Dec. 4, 2019.

In the example of FIG. 12B, Job ID “#025_P” in a setting history information display area R23 of a screen W80 is a job ID for the 25th print job, and the job execution date and time is 10:30:50 on Dec. 4, 2019. The set values for this job are set value item: “full color” of full color/black and white printing, set value item: “A4” of paper size, and set value item: “plain paper” of paper type.

Similarly, Job ID “#024_P” in a setting history information display area R25 is a job ID for the 24th print job, and the job execution date and time is 10:15:30 on Dec. 4, 2019. The set values of this job are set value items: “black and white” of full color/black and white printing, “B4” of paper size, and set value item: “plain paper” of paper type.

Similarly, Job ID “#023_S” in a setting history information display area R27 is a job ID for the 23rd scan job, and the job execution date and time is 9:30:30 on Dec. 4, 2019. The set values of this job are set value item: “text” of text/photo, set value item: “A4” of paper size, set value item: “200 dpi×200 dpi” of resolution.

FIG. 12C is a screen display example of a result of sorting process in a case where the function pertaining to the job is a printer.

In the example of FIG. 12C, Job ID “#025_P” in a setting history information display area R29 of a screen W90 is a job ID for the 25th print job, and the job execution date and time is 10:30:50 on Dec. 4, 2019. The set values of this job are set value item: “full color” of full color/black and white printing, set value item: “A4” of paper size, and set value item: “plain paper” of paper type.

Similarly, Job ID “#024_P” in a setting history information display area R31 is a job ID for the 24th print job, and the job execution date and time is 10:15:30 on Dec. 4, 2019. The set values of this job are set value item: “black and white” of full color/black and white printing, set value item: “B4” of paper size, and set value item: “plain paper” of paper type.

Similarly, Job ID “#021_P” in a setting history information display area R33 is a job ID for the 21st print job, and the job execution date and time is 8:30:00 on Dec. 4, 2019. The set values of this job are set value item: “black and white” of full color/black and white printing, set value item: “A4” of paper size, set value item: “plain paper” of paper type.

FIG. 12D is a screen display example of a result of sorting process of a case where a priority display identifier attached to the setting history information is “(asterisk)”.

In the example of FIG. 12D, Job ID “#025_P” in a setting history information display area R35 of a screen W100 is a job ID for the 25th print job, and the job execution date and time is 10:30:50 on Dec. 4, 2019. This setting history information is marked with “(asterisk)” as the priority display identifier, and the set values of the this job are set value item: “full color” of full color/black and white printing, set value item: “A4” of paper size, and set value item: “plain paper” of paper type.

Similarly, Job ID “#024_P” in a setting history information display area R37 is a job ID for the 24th print job, and the job execution date and time is 10:15:30 on Dec. 4, 2019. This setting history information is marked with “(asterisk)” as the priority display identifier, and the set values of the this job are set value item: “black and white” of full color/black and white printing, set value item: “B4” of paper size, and set value item: “plain paper” of paper type.

FIGS. 13A to 13B is a configuration example of the set value search screen W60 displayed by the controller 11 by receiving the press of the set value search button B15 of FIG. 10.

This set value search screen W60 includes a job ID selection tab T21, a job function selection tab T23, a paper selection tab T25, and a full color/black and white selection tab T27.

The job ID selection tab T21 is a tab that receives the selection of a job ID as a target of a search set value.

The job function selection tab T23 is a tab that receives the selection of a job function as a target of the search set value.

The paper selection tab T25 is a tab that receives the selection of paper (size) as a target of the search set value.

The full color/black and white selection tab T27 is a tab that receives the selection of (full) color/black and white (printing) as a target of the search set value.

A user can search for setting history information including the search set value by selecting a predetermined set value as the search set value via the set value search screen W60.

Herein, FIG. 13A illustrates a result obtained by selecting a search set value “print” via the job function selection tab T23 by the user, and performing a first search based on this search set value. As illustrated in the job ID on the lower surface (in the dotted line area) of the set value search screen W60, it can be seen that pieces of the setting history information pertaining to a print job as a job function are listed as candidates to be searched by the first search.

FIG. 13B illustrates a result obtained by selecting a search set value “black and white” via the color/black and white selection tab T27 as a second search, following the first search, and performing the second search based on this search set value. It can be seen that the setting history information of Job ID “#20_P” which is also a print job and includes set value item: “black and white” of full color/black and white printing as a set value is listed as a new search target candidate (the lower surface of the set value search screen W60 (in the dotted line area)), in response to the first search result, instead of the setting history information of Job ID “#025_P”. The set values items used in the set value search are not limited to the set values for the job ID, the job function, the paper (size), and the full color/black and white, and other set values can also be used.

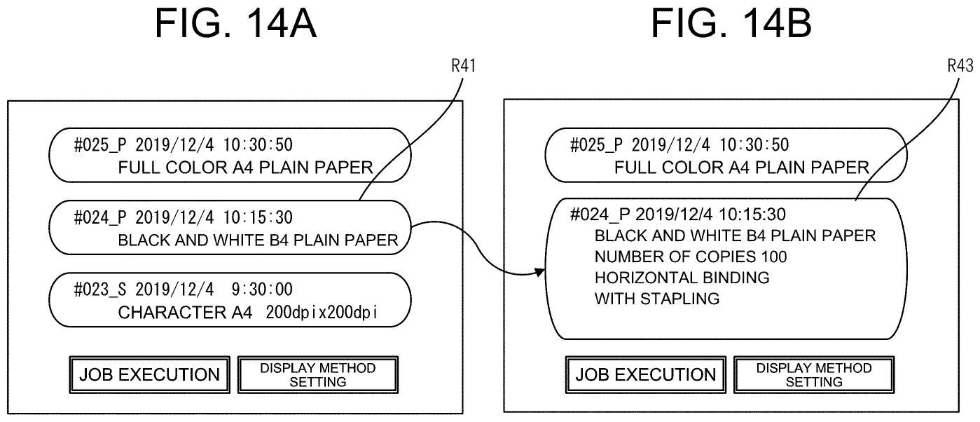

FIGS. 14A to 14B is a screen display example of a result of an enlarged display process of setting history information corresponding to a job ID received via the enlarged display input tab T15 of FIG. 10.

FIG. 14A is a screen display example of a case where the enlarged display process is not yet executed, and FIG. 14B is a screen display example of a case where the enlarged display process is already executed. Herein, a case where the setting history information pertaining to Job ID “#024_P” is selected as the target of the enlargement display process will be described as an example.

As illustrated in FIG. 14A, in a setting history information display area R41 pertaining to Job ID “#024_P”, the set values of set value item: “black and white” of full color/black and white, set value item: “of B4” of paper size, set value item: “plain paper” of paper type are displayed as set values. On the other hand, in a setting history information display area R43 after the enlarged display process, illustrated in FIG. 14B, in addition to these set values, the set values in which set value item: “100” of the number of copies, set value item: “horizontal binding” of double-sided printing, and set value item: “with stapling” of finishing function are added are enlarged and displayed. The set values to be displayed in the enlarged display process are not limited to these, and can be appropriately selected.

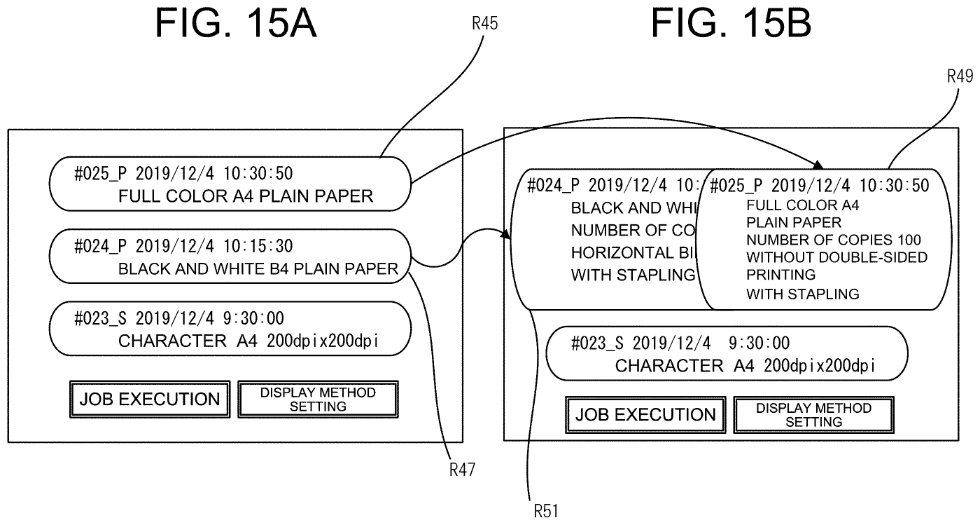

FIGS. 15A to 15B is a screen display example of a result of a contrast display process of pieces of setting history information corresponding to job IDs received via the contrast display input tab T17 of FIG. 10.

FIG. 15A is a screen display example of a case where the contrast display process is not yet executed, and FIG. 15B is a screen display example of a case where the contrast display process is already executed. Herein, a case where the setting history information pertaining to Job ID “#024_P” and the setting history information pertaining to Job ID “#025_P” are selected as the targets of the contrast display process will be described as an example.

As illustrated in FIG. 15A, in a setting history information display area R45 pertaining to Job ID “#025_P”, the set values of set value item: “full color” of full color/black and white, set value item: “A4” of paper size, set value item: “plain paper” of paper type are displayed as set values. Similarly, in a setting history information display area R47 pertaining to Job ID “#024_P”, the set values of set value item: “black and white” of full color/black and white, set value item: “B4” of paper size, set value item: “plain paper” of paper type are displayed as set values.

On the other hand, in a setting history information display area R49 after the contrast display process, illustrated in FIG. 15B, in addition to the set values displayed on the setting history information display area R45, the set values in which set value item: “100” of the number of copies, set value item: “without double-sided printing” of double-sided printing, and set value item: “with stapling” of finishing function are added are displayed. Similarly, in a setting history information display area R51 after the contrast display process, in addition to the set values displayed on the setting history information display area R47, the set values in which set value item: “100” of the number of copies, set value item: “horizontal binding (partially hidden)” of double-sided printing, and set value item: “with stapling” of finishing function are added are displayed in contrast. The setting history information display areas R49 and R51 are displayed in parallel after the enlargement process so as to facilitate the contrast of both the pieces of setting history information. The set values to be displayed in the contrast display process are not limited to these, and can be selected as appropriate.

As described above, according to the first embodiment, the setting history information is displayed for a user, so that the grasp of the setting contents pertaining to job execution is facilitated, and job execution from the setting history information is enabled, and therefore it is possible to improve the convenience pertaining to the job execution. Furthermore, the display configuration of the setting history information is configured to support not only the chronological display of job execution but also the sorting process, the enlargement display, and the contrast display process based on predetermined input values and set values, and therefore a more convenient interface can be provided to a user.

### 2. Second Embodiment

Next, a second embodiment will be described. The second embodiment is an embodiment in which, in a contrast display process for a screen display of setting history information, a changed part where a set value is changed is highlighted. In the second embodiment, the same reference numerals denote functional parts and processes identical to the functional parts and the processes of the first embodiment, and description thereof will be omitted.

### 2.1 Functional Configuration

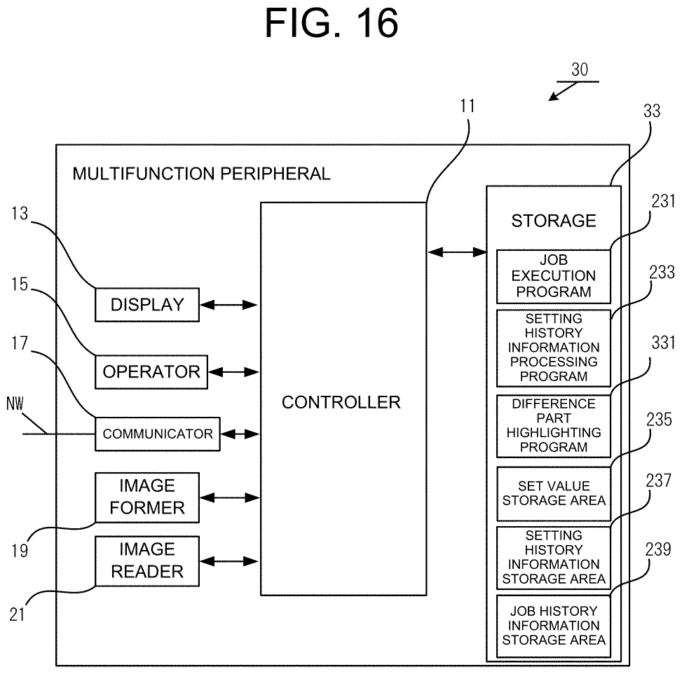

FIG. 16 is a functional configuration diagram of a multifunction peripheral 30 according to the second embodiment. The multifunction peripheral 30 according to the second embodiment includes a storage 33 instead of the storage 23 of the multifunction peripheral 10.

In the second embodiment, the storage 33 stores a job execution program 231, a setting history information processing program 233, and a difference part highlighting program 331, and secures a set value storage area 235, a setting history information storage area 237, and a job history information storage area 239.

The difference part highlighting program 331 is a program that a controller 11 reads out when a changed part where a set value is changed between pieces of setting history information is highlighted in a contrast display process for setting history information.

### 2.2 Flow of Process

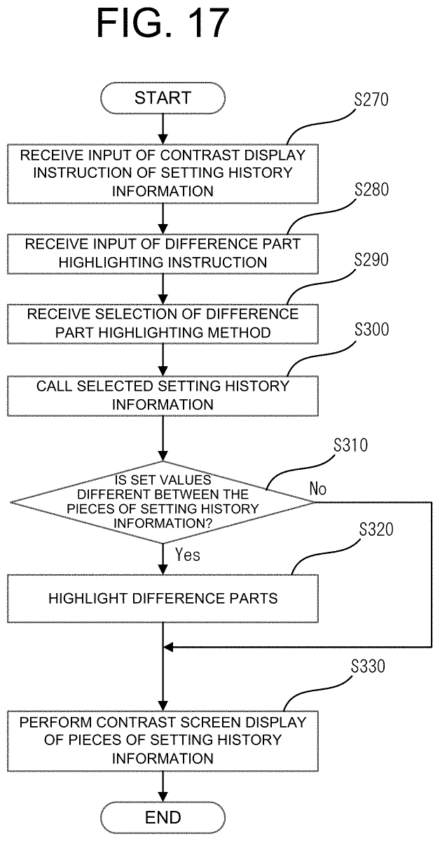

Now, a process mainly executed by the controller 11 from the reception of the input of an contrast display instruction for pieces of the setting history information to the contrast screen display of pieces of the setting history information will be described with reference to a flowchart in FIG. 17.

The controller 11 executes this process by reading the setting history information processing program 233 and the difference part highlighting program 331.

In Step S270, the controller 11 receives the input of a contrast display instruction of pieces of the setting history information by a user. In this case, the user selects setting history information pertaining to contrast display. Then, in Step S280, the controller 11 receives the input of an difference part highlighting instruction by the use.

Next, the controller 11 receives the selection of a difference part highlighting method by the user (Step S290). Then, the controller 11 reads out pieces of the setting history information selected from the setting history information storage area 237 by the user when the input of the contrast display instruction of pieces of the setting history information is received (Step S300).

The controller 11 reads out, from the set value storage area 235, set values pertaining to pieces of the setting history information read out from the setting history information storage area 237. By comparing the set values of pieces of the setting history information for the contrast display process, the controller 11 determines whether or not the set values are different between the pieces of setting history information.

When it is determined that the set values are different between the pieces of setting history information (Yes in Step S310), the controller 11 highlights difference parts by the difference part highlighting method received in Step S290 (Step S320).

Then, the controller 11 performs the contrast screen display of the pieces of setting history information (Step S330) and ends the process.

On the other hand, when it is determined that the set values are not different between the pieces of setting history information (No in Step S310), the controller 11 performs contrast screen display for the pieces of setting history information (Step S330) and ends the process.

### 2.3 Operation Example

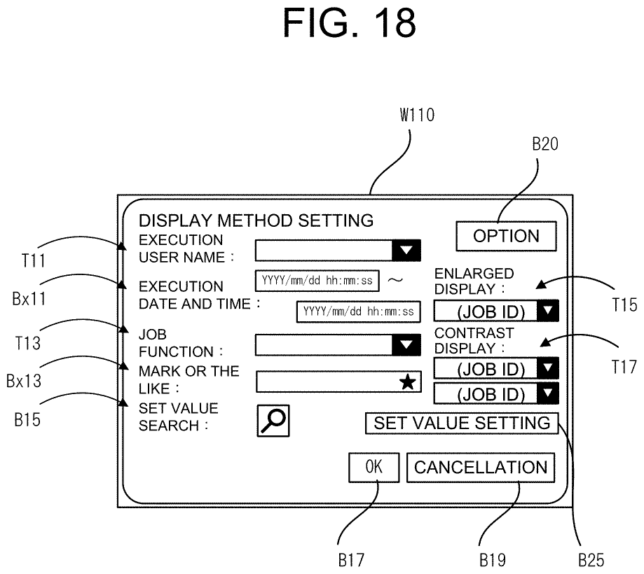

FIG. 18 is a configuration example of a display method setting screen W110 according to this embodiment. The display method setting screen W110 includes a set value setting button B25 in addition to the configuration of the display method setting screen W40 according to the first embodiment.

The set value setting button B25 is an item selected by the user when a changed part where the set value is changed between the pieces of setting history information is highlighted in the setting history information contrast display process. Upon receiving the press of the set value setting button B25, the controller 11 displays a set value setting screen W120 on the screen.

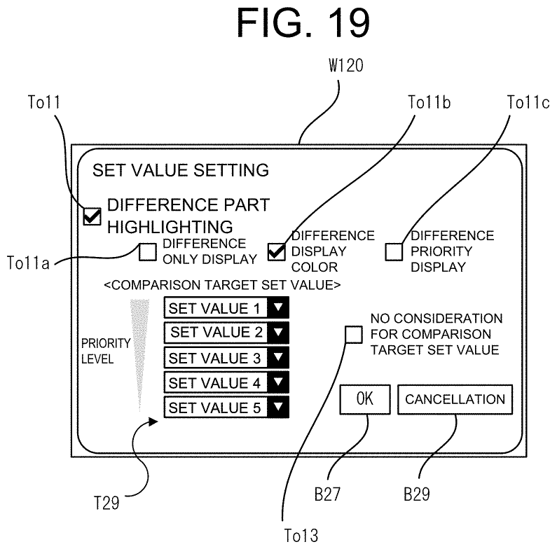

FIG. 19 is a configuration example of the set value setting screen W120 displayed on the screen by the controller 11. The set value setting screen W120 includes a difference part highlighting check box To11, a comparison target set value selection tab T29, an OK button B27, and a cancellation button B29.

The difference part highlighting check box To11 is a check box that is selected when set values different between the pieces of the setting history information are highlighted in the setting history information contrast display process. The difference part highlighting check box To11 includes a difference only display check box To11a, a difference display color check box To11b, and a difference priority display check box To11c, which are selected according to a highlighting type.

The comparison target set value selection tab T29 is a tab that receives the selection of set values as a target of difference comparison according to the priority of the user. For example, when set value item: full color/black and white is selected as a set value 1 by the user, the controller 11 highlights parts where the set values of set value item: full color/black and white are different. In the comparison target set value selection tab T29, set value items from the set value 1 to a set value 5 can be selected. The set values to be compared can be provided with a priority level from the set value 1 to the set value 5.

A check box To13 for no consideration for comparison target set value is a check box selected, for example, when the controller 11 is made to highlight difference parts on the basis of a preset initial value. In this case, the set value selected by the comparison target set value selection tab T29 is ignored.

The OK button B27 is a button that receives input approval by a user. The cancellation button B29 is a button that receives input cancellation by a user.

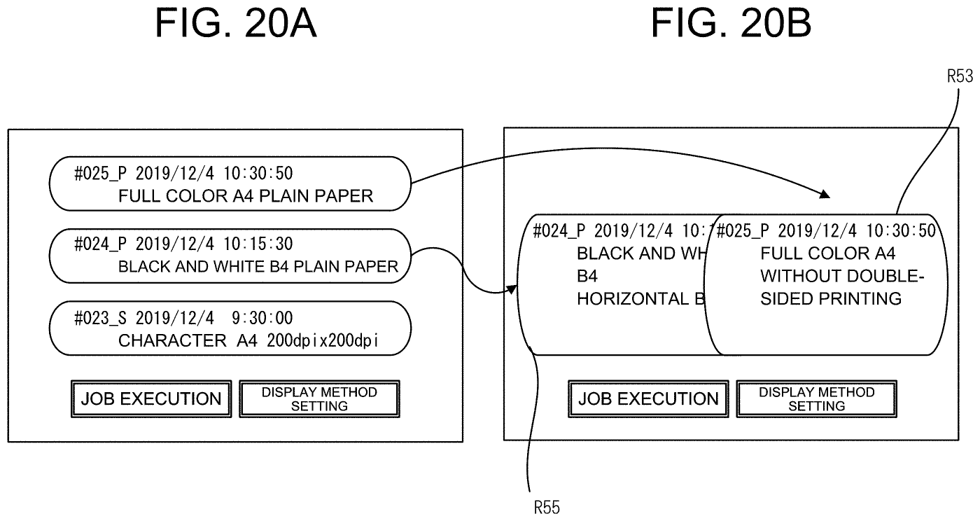

FIGS. 20A to 20B is a screen display example of a result of a highlighting process performed when the difference only display check box To11a of the difference part highlighting check box To11 is selected.

FIG. 20A a screen display example of a case where the highlighting process is not yet executed, and FIG. 20B is a screen display example of a case where the highlighting process is already executed. Herein, a case where the setting history information pertaining to Job ID “#024_P” and the setting history information pertaining to Job ID “#025_P” are selected as the targets of the contrast display process will be described as an example.

The controller 11 displays, in a setting history information display area R53 and a setting history information display area R55, only respective set values different between the setting history information of Job ID “#025_P” and the setting history information of Job ID “#024_P”.

In the example illustrated in FIG. 20B, in the setting history information display area R53 pertaining to Job ID “#025_P”, set value item: “full color” of full color/black and white printing, set value item: “A4” of paper size, and set value item: “without double-sided printing” of double-sided printing are displayed as the difference from the set values pertaining to Job ID “#024_P”.

Similarly, in the setting history information display area R55 pertaining to Job ID “#024_P”, set value item: “black and white” of full color/black and white printing, set value item: “B4” of paper size, and set value item: “horizontal binding” of double-sided printing are displayed as the difference from the set values pertaining to Job ID “#025_P”.

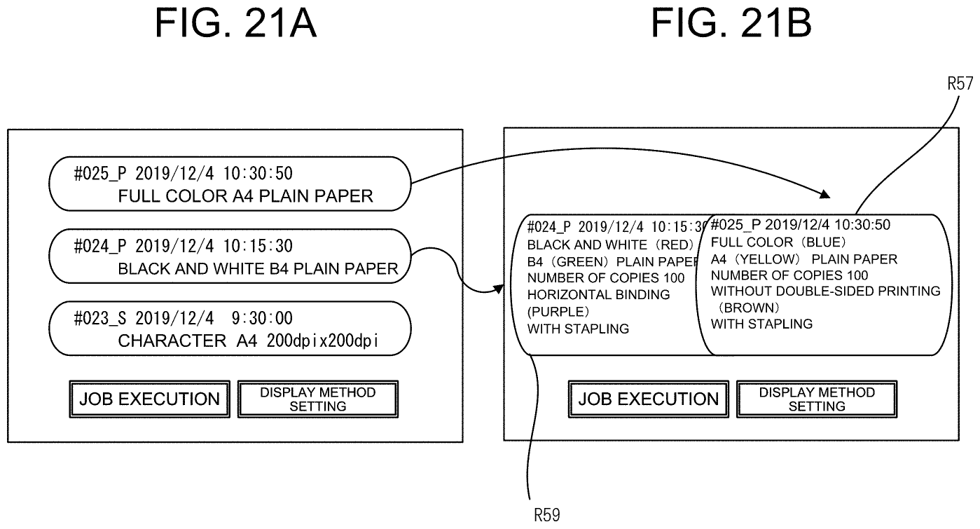

FIGS. 21A to 21B is a screen display example of a result of a highlighting process performed when the difference display color check box To11b of the difference part highlighting check box To11 is selected.

FIG. 21A is a screen display example of a case where the highlighting process is not yet executed, and FIG. 21B is a screen display example of a case where the highlighting process is already executed. Herein, a case where the setting history information pertaining to Job ID “#024_P” and the setting history information pertaining to Job ID “#025_P” are selected as the targets of the contrast display process will be described as an example.

The controller 11 displays the respective different set values in the setting history information of Job ID “#025_P” and the setting history information of Job ID “#024_P” with different display colors in a setting history information display area R57 and a setting history information display area R59.

In the example illustrated in FIG. 21B, in the setting history information display area R57 pertaining to Job ID “#025_P”, set value item: “full color” of full color/black and white printing, set value item: “A4” of paper size, set value item: “plain paper” of paper type, set value item: “100” of the number of copies, set value item: “without double-sided printing” of double-sided printing, and set value item: “with stapling” of finishing function are displayed as the set values. Among these, as the difference from the set values pertaining to Job ID “#024_P”, for example, set value item: “full color” of full color/black and white printing is displayed in blue, set value item: “A4” of paper size is displayed in yellow, and set value item: “without double-sided printing” of double-sided printing is displayed in brown.

Similarly, in the setting history information display area R59 pertaining to Job ID “#024_P”, set value item: “black and white” of full color/black and white printing, set value item: “B4” of paper size, set value item: “plain paper” of paper type, set value item: “100” of the number of copies, set value item: “horizontal binding” of double-sided printing, and set value item: “with stapling” of finishing function are displayed as the set values. Among these, as the difference from the set values pertaining to Job ID “#025_P”, for example, set value item: “black and white” of full color/black and white printing is displayed in red, set value item: “B4” of paper size is displayed in green, and set value item: “horizontal binding” of double-sided printing is displayed in purple.

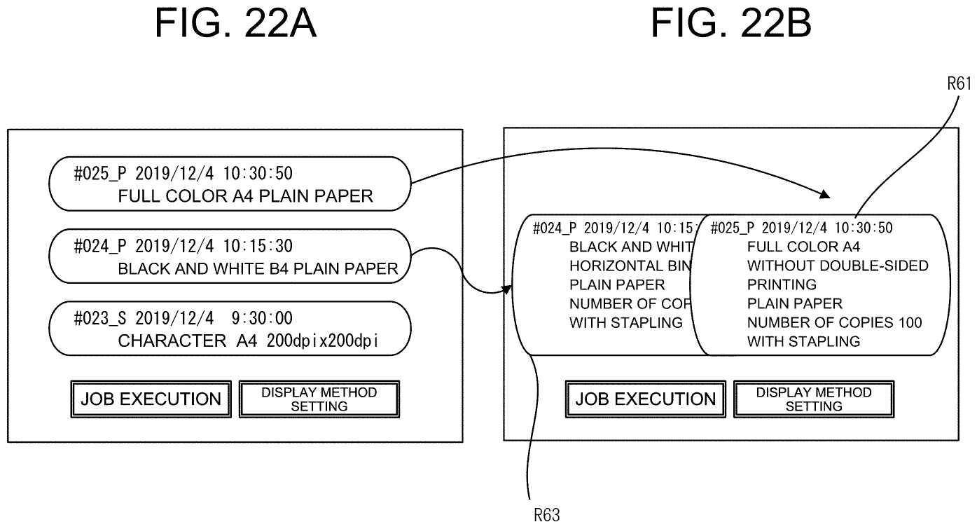

FIGS. 22A to 22B is a screen display example of a result of the highlighting process performed when the difference priority display check box To11c of the difference part highlighting check box To11 is selected.

FIG. 22A is a screen display example of a case where the highlighting process is not yet executed, and FIG. 22B is a screen display example of a case where the highlighting process is already executed. Herein, a case where the setting history information pertaining to Job ID “#024_P” and the setting history information pertaining to Job ID “#025_P” are selected as the targets of the contrast display process will be described as an example.

The controller 11 preferentially displays, in a setting history information display area R61 and a setting history information display area R63, the respective set values different between the setting history information of Job ID “#025_P” and the setting history information of Job ID “#024_P”.

In the example illustrated in FIG. 22B, in the setting history information display area R61 pertaining to Job ID “#025_P”, set value item: “full color” of full color/black and white printing, set value item: “A4” of paper size, set value item: “plain paper” of paper type, set value item: “100” of the number of copies, set value item: “without double-sided printing” of double-sided printing, and set value item: “with stapling” of finishing function are displayed as set values. Among these, as the difference from set values pertaining to Job ID “#024_P”, set value item: “full color” of full color/black and white printing, set value item: “A4” of paper size, and set value item: “without double-sided printing” of double-sided printing are displayed preferentially in an upper portion of the setting history information display area R61.

Similarly, in the setting history information display area R63 pertaining to Job ID “#024_P”, set value item: “black and white” of full color/black and white printing, set value item: “B4” of paper size, set value item: “plain paper” of paper type, set value item: “100” of the number of copies, set value item: “horizontal binding” of double-sided printing, and set value item: “with stapling” of finishing function are displayed as set values. Among these, as the difference from the set values pertaining to Job ID “#025_P”, set value item: “black and white” of full color/black and white printing, set value item: “B4” of paper size, and set value item: “horizontal binding” of double-sided printing are displayed preferentially in an upper portion of the setting history information display area R63.

As described above, according to the second embodiment, in addition to the effects of the first embodiment, the changed part where the set value is changed is highlighted, and therefore the job contents can be grasped more visually and accurately in the contrast display between the pieces of setting history information.

### 3. Third Embodiment

Next, a third embodiment will be described. The third embodiment is an embodiment in which, in a screen display of setting history information, a sorting result of setting history information according to the number of times of job execution is displayed on a screen. In the third embodiment, the same reference numerals denote functional parts and processes identical to the functional parts and the processes of the first embodiment, and description thereof will be omitted.

### 3.1 Functional Configuration

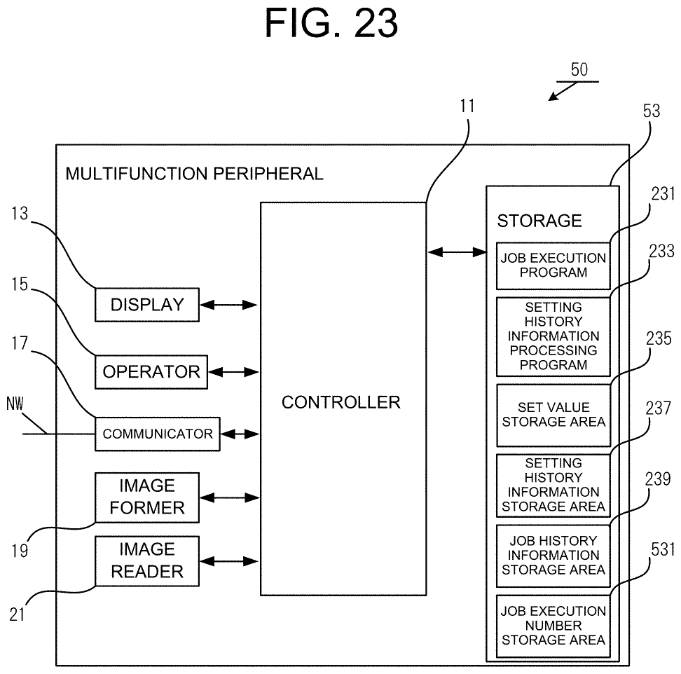

FIG. 23 is a functional configuration diagram of a multifunction peripheral 50 according to the third embodiment. The multifunction peripheral 50 according to this embodiment includes a storage 53 instead of the storage 23 of the multifunction peripheral 10.

In this embodiment, the storage 53 stores a job execution program 231 and a setting history information processing program 233, and secures a set value storage area 235, a setting history information storage area 237, a job history information storage area 239, and a job execution number storage area 531.

The job execution number storage area 531 is a storage area in which the number of times of job execution is stored.

### 3.2 Flow of Process

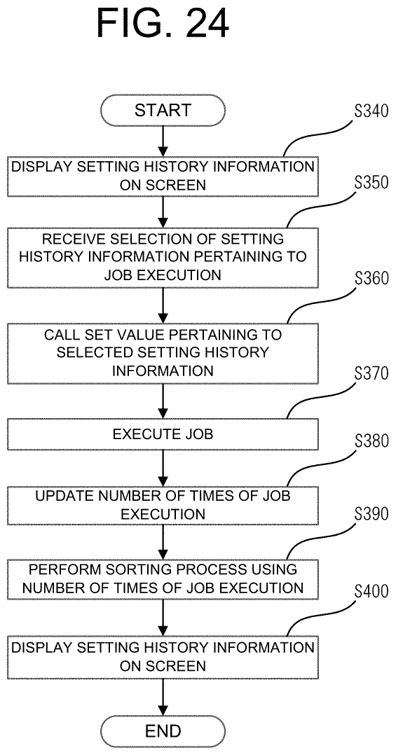

Now, a process mainly executed by a controller 11 from the screen display of the setting history information to the screen redisplay of the setting history information will be described with reference to a flowchart in FIG. 24.

The controller 11 executes this process by reading out the setting history information processing program 233 and the job execution program 231.

The controller 11 displays the setting history information on the screen on the basis of the process described in FIG. 4 to FIG. 7 and the like. (Step S340).

When a user selects the setting history information pertaining to job execution from the setting history information displayed on the screen, the controller 11 receives this selection (Step S350).

In Step S360, the controller 11 calls a set value pertaining to the selected setting history information from the set value storage area 235.

The controller 11 executes a job by using the called set value (Step S370).

The controller 11 calls the number of times of job execution corresponding to the executed job from the job execution number storage area 531. Then, the controller 11 updates the number of times of job execution by incrementing the number of times of called job execution (Step S380).

Next, the controller 11 performs a sorting process for pieces of the setting history information by using the number of times of job execution (Step S390).

In Step S400, the controller 11 displays a sorting result of the pieces of setting history information on the screen.

### 3.3 Operation Example

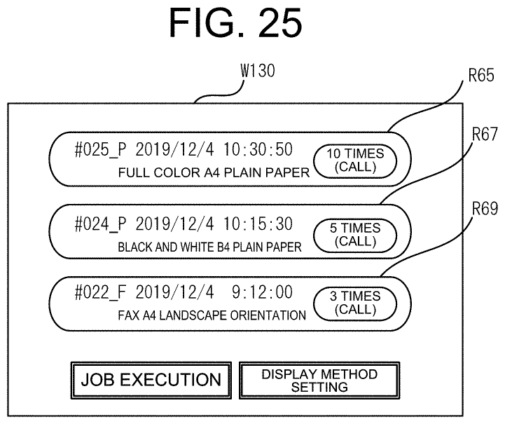

FIG. 25 is a screen display example of a result of a setting history information sorting process based on the number of times of job execution.

In the example of FIG. 25, Job ID “#025_P” in a setting history information display area R65 is a job ID for the 25th print job, and the job execution date and time is 10:30:50 on Dec. 4, 2019. The set values for this job are set value item: “full color” of full color/black and white printing, set value item: “A4” of paper size, and set value item: “plain paper” of paper type. It is indicated that the job pertaining to this setting history information indicates was called and executed 10 times.

Similarly, Job ID “#024_P” in a setting history information display area R67 is a job ID for the 24th print job, and the job execution date and time is 10:15:30 on Dec. 4, 2019. The set values of this job are set value items: “black and white” of full color/black and white printing and “B4” of paper size, and set value item: “plain paper” of paper type. It is indicated that the job pertaining to this setting history information was called and executed 5 times.

Similarly, Job ID “#022_F” in a setting history information display area R69 is a job ID for the 22nd fax job, and the job execution date and time is 9:12:00 on Dec. 4, 2019. The set values for this job are set value item: “fax” of fax/data transmission, set value item: “A4” of paper type, and set value item: “landscape orientation” of document orientation. It is indicated that the job pertaining to this setting history information was called and executed 3 times.

As described above, according to the third embodiment, in addition to the effects of the first embodiment, pieces of the setting history information are sorted according to the number of times of job execution, and are displayed with the number of times of job execution in the job execution order from the larger number of times of job execution. Therefore, a user can accurately grasp the job contents (setting history information) pertaining to a frequently used job.

The present invention is not limited to the aforementioned embodiments, and various modifications can be made. That is, embodiments obtained by combining techniques appropriately changed without departing from the gist of the present invention are also included in the technical scope of the present invention.

In addition, although the aforementioned embodiments are described separately for convenience of explanation, it is needless to say that the embodiments may be combined and executed within the technically possible range.

The program that operates in each device in the embodiments is a program that controls a CPU or the like (a program that causes a computer to function) so as to implement the functions of the above embodiments. Moreover, the information handled by these devices is temporarily stored in a temporary storage device (for example, a RAM) at the time of processing, and then stored in various storage devices such as a ROM (Read Only Memory) and an HDD, and is read out, corrected, and written by the CPU as needed.

Herein, examples of a storage medium for storing the program may include a semiconductor medium (such as a ROM and a non-volatile memory card), an optical storage medium/magneto-optical storage medium (such as a Digital Versatile Disc (DVD), a Magneto Optical Disc (MO), a Mini Disc (MD), a Compact Disc (CD), and a Blu-ray Disc (BD) (registered trademark)), and a magnetic storage medium (such as magnetic tape and a flexible disk). In addition, the functions of the above embodiments are implemented by executing a loaded program. In some cases, the functions of the present invention are implemented by processing in collaboration with the operating system or other application program on the basis of the instructions of the program.

Furthermore, in the case of distribution to the market, the program can be stored and distributed in a portable recording medium, or transferred to a server computer connected via a network such as the Internet. In this case, of course, a storage device of the server computer is also included in the present invention.

What is claimed is:

1. An image forming apparatus capable of executing a job on the basis of a set value, and storing a history of the job, the image forming apparatus comprising:
a storage that stores, as setting history information, the set value of the executed job;
a display that displays the setting history information stored in the storage; and
a controller that executes the job based on the setting history information displayed on the display, wherein
when the controller receives a display change instruction for the setting history information, the controller changes a display format of the setting history information from execution order of the job to a display format pertaining to the display change instruction.

2. The image forming apparatus according to claim 1, wherein
a sorting process based on a predetermined input value is included in the display change instruction for the setting history information.

3. The image forming apparatus according to claim 2, wherein
any of an execution user name of the job, execution date and time of the job, a function of the job, a priority display identifier, and the set value is included in the predetermined input value.

4. The image forming apparatus according to claim 1, wherein
the controller changes the display format of the setting history information by performing an enlarged display process for a specific one piece of the setting history information.

5. The image forming apparatus according to claim 1, wherein
the controller changes the display format of the setting history information by performing a contrast display process for a plurality of pieces of the setting history information.

6. The image forming apparatus according to claim 5, wherein
the contrast display process includes highlighting for highlighting a changed part in which the set value is changed.

7. The image forming apparatus according to claim 6, wherein
the highlighting includes any of difference part display for displaying only difference parts different from the plurality of pieces of setting history information to be contrasted, difference part display color change for changing display colors of the difference parts, or difference part priority display for preferentially displaying the difference parts.

8. The image forming apparatus according to claim 1, wherein
the storage stores the number of times of execution of the job, and the controller changes the display format of the setting history information by performing a sorting process of the setting history information on the basis of the number of times of the execution of the job.

9. A control method for an image forming apparatus capable of executing a job on the basis of a set value, and storing a history of the job, the control method comprising:
storing, as setting history information, the set value of the executed job;
displaying the setting history information stored in the storing; and
controlling execution of the job based on the setting history information displayed in the displaying, wherein
in the controlling, when a display change instruction for the setting history information is received, a display format of the setting history information is changed from execution order of the job to a display format pertaining to the display change instruction.
